(19) United States
(12) Patent Application Publication
(10) Pub. No.: US 2009/0197158 A1
(43) Pub. Date: Aug. 6, 2009

(54) NONAQUEOUS ELECTROLYTE BATTERY

(75) Inventors: Kenichi Ogawa, Kanagawa (JP); Atsushi Kajita, Fukushima (JP); Yukako Teshima, Fukuoka (JP); Atsushi Nishimoto, Fukushima (JP); Shinichi Hamasaki, Fukushima (JP); Yoshikatsu Yamamoto, Fukushima (JP); Hiroshi Imoto, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/357,173

(22) Filed: Jan. 21, 2009

(30) Foreign Application Priority Data
Feb. 4, 2008 (JP) 2008-023940

(51) Int. Cl. H01M 2/16

(52) U.S. Cl. 429/144

(57) ABSTRACT

A nonaqueous electrolyte battery includes a cathode that is placed opposite an anode via a separator, an open circuit voltage in the full charge state is within a range of 4.25 to 6.00 V per a pair of the cathode and the anode, the separator includes a base material layer which includes a polyolefin resin material and a surface layer which is provided at least on the surface at the side of the cathode of the base material layer and includes at least one selected from the group including polyvinylidene fluoride, polytetrafluoroethylene, and polypropylene, and at least one selected from the group including aramid, polyimide, and ceramics is present on the outermost surface of the surface layer.

### CROSS REFERENCES TO RELATED APPLICATIONS

The present application claims priority to Japanese Patent Application JP 2008-023940 filed in the Japanese Patent Office on Feb. 4, 2008, the entire contents of which is being incorporated herein by reference.

### BACKGROUND

The present disclosure relates to a nonaqueous electrolyte battery using a separator containing polyolefin resin materials, particularly a nonaqueous electrolyte battery that achieves high quality when it is used at a high charging voltage.

With the remarkable development of the portable electronics in recent years, cellular phones and notebook computers have been recognized as infrastructure technologies for an advanced information society. Further, the research and development related to the high-performance of these devices have been intensively preceded and power consumption has been increasing in proportion thereto. On the other hand, there is a need to drive these electronic devices for long periods of time. Inevitably, there is a need to densify an energy density of a secondary battery to be used as a driving source.

From the viewpoint of the occupied volume and weight of the battery in the electronic device, the higher energy density of the battery is desirable. Currently, lithium-ion secondary battery is built in most electronic devices because it has an excellent energy density.

Usually, in the lithium-ion secondary battery, lithium cobaltate is used for the cathode and carbon materials are used for the anode. The operating voltage is in the range of 4.2 to 2.5 V. In the case of single cells, the terminal voltage is increased to 4.2 V. This is largely based on excellent electrochemical stability of nonaqueous electrolyte materials and the separator.

With reference to the lithium-ion secondary battery which operates at up to 4.2 V, on the basis of the theoretical capacity, about 60 percent of a cathode active material (e.g. lithium cobaltate) to be used for the battery is merely utilized. Further, the remaining capacity can be utilized by increasing the charging voltage in principle. As disclosed in, for example, International Publication No. 03/019713, it is known that a high energy density can be realized by setting the voltage at the time of charging to 4.25 V or more.

However, in the case of the battery in which the charging voltage is set to more than 4.2 V, the oxidative atmosphere in the vicinity of the surface of the cathode is increased particularly. As a result, the nonaqueous electrolyte material and the separator which physically comes into contact with the cathode are oxidatively decomposed. Thus, a micro-short circuit easily occurs, particularly in a hot environment and battery characteristics such as cycle characteristics and high temperature storage characteristics are reduced.

Japanese Patent Application Laid-Open (JP-A) No. 2006-286531 discloses the battery using the separator in which polyethylene (PE) is used as a base material and a stacked film which includes at least one selected from the group including polyvinylidene fluoride (PVdF), polytetrafluoroethylene (PTFE), polypropylene (PP), and aramid is formed on the surface at the opposite side of the cathode of the base material. The oxidative decomposition of the surface of the separator can be suppressed by using at least one of polyvinylidene fluoride, polytetrafluoroethylene, polypropylene, and aramid which have a high electrochemical stability for the surface at the opposite side of the cathode under a high oxidative atmosphere.

However, in the separator in which the outermost surface includes polyvinylidene fluoride (PVdF), polytetrafluoroethylene (PTFE), and polypropylene (PP), it is difficult to form a micro-porous structure by the wet biaxial stretching method. Therefore, it is necessary to allow holes to be easily formed by, for example, adding an inorganic filler or increasing the draw ratio when the resin materials are stretched. However, the separator produced in such a manner has a low thermal stability and heat shrinkage is easily caused as compared to the separator of polyethylene (PE) monolayer.

Alternatively, the micro-porous structure can be easily formed by the dry uniaxial stretching method. However, since the stretching is carried out only in one direction, heat shrinkage in one direction is significantly increased as compared to the case where the separator is formed by the biaxial stretching method.

The battery in which the charging voltage is set to more than 4.2 V has a higher risk caused by incorrect use than the battery in the past. Therefore, it is necessary to further improve safety.

Therefore, it is desirable to provide a nonaqueous electrolyte battery capable of balancing high safety and high battery performance even when the charging voltage is set to more than 4.2 V in order to solve the problems.

### SUMMARY

According to an embodiment, there is provided a nonaqueous electrolyte battery in which a cathode is placed opposite an anode via a separator, an open circuit voltage in the full charge state is within a range of 4.25 to 6.00 V per a pair of the cathode and the anode, the separator has a base material layer which includes a polyolefin resin material and a surface layer which is provided at least on the surface at the side of the cathode of the base material layer and includes at least one selected from the group including polyvinylidene fluoride, polytetrafluoroethylene, and polypropylene, and at least one selected from the group including a wholly aromatic polyamide resin, polyimide, and ceramics is present on the outermost surface of the surface layer.

In the nonaqueous electrolyte battery, it is preferable that a coating layer is provided on at least one outermost surface of the separator, the coating layer containing at least one selected from the group consisting of a wholly aromatic polyamide resin, polyimide, and ceramic.

In the nonaqueous electrolyte battery, it is preferable that the ratio of the thickness of the base material layer to the thickness of the surface layer is in the range of 1:0.05 to 1:1 since shutdown characteristics can be maintained by the polyethylene layer.

In the nonaqueous electrolyte battery, it is preferable that the thickness of the coating layer is 0.5 μm or more and 5 μm or less in order to reduce the decrease in the battery capacity due to the increase in the thickness of the separator.

With reference to the nonaqueous electrolyte battery, it is preferable that the air permeability of the separator is in the range of 100 sec/100 cc to 600 sec/100 cc from the viewpoint of the balance between battery characteristics and safety. Further, it is preferable that the porosity of the separator is 25% or more and 60% or less and the thrust strength of the separator is 200 gf or more and 1000 gf or less for a similar reason.

In an embodiment, the oxidative decomposition of the separator can be suppressed by providing a surface layer which includes at least one selected from the group including polyvinylidene fluoride, polytetrafluoroethylene and polypropylene which are excellent in electrochemical stability at least on the surface at the side of the cathode of the base material layer which includes the polyolefin resin material and can exhibit a shutdown effect when a resin material is melted at a predetermined temperature. Further, the heat shrinkage of the separator with the temperature rise in the battery can be suppressed by allowing at least one selected from the group including aramid, polyimide, and ceramics which have a high thermal stability to be present on the surface of the surface layer.

According to an embodiment, a nonaqueous electrolyte battery capable of preventing the short circuit of the cathode and the anode due to the oxidative decomposition and the heat shrinkage of the separator and balancing high safety and high battery performance can be obtained.

Additional features and advantages are described herein, and will be apparent from the following Detailed Description and the figures.

### BRIEF DESCRIPTION OF THE FIGURES

FIG. 1 is a cross-sectional view showing a structural example of the nonaqueous electrolyte battery according to an embodiment.

FIG. 2 is a partly enlarged cross-sectional view showing the spiral electrode body which is used for the nonaqueous electrolyte battery according to an embodiment.

FIG. 3A and FIG. 3B are cross-sectional views showing a structural example of the separator which is used for the nonaqueous electrolyte battery according to an embodiment.

FIG. 4A, FIG. 4B and FIG. 4C are cross-sectional views showing another structural example of the separator which is used for the nonaqueous electrolyte battery according to an embodiment.

### DETAILED DESCRIPTION

Hereinafter, an embodiment will be described with reference to the accompanying drawings.

### [Structure of Nonaqueous Electrolyte Battery]

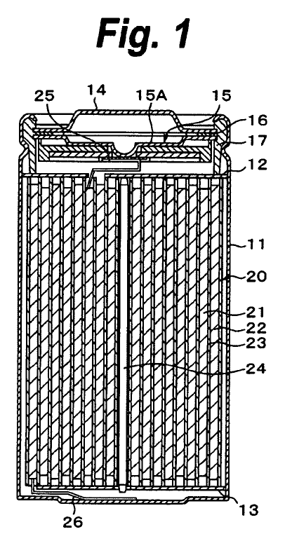

FIG. 1 is a cross-sectional view showing an example of the structure of the nonaqueous electrolyte secondary battery (hereinafter conveniently referred to as the secondary battery) according to the first embodiment. The secondary battery is a so-called lithium-ion secondary battery in which the capacity of the anode is represented by a capacity component determined by occlusion and release of lithium (Li) and lithium is used as an electrode reaction substance. This secondary battery is a so-called cylindrical shape and includes a spiral electrode body 20 in which a pair of a band-like cathode 21 and a band-like anode 22 are stacked and wound via a separator 23 in a hollow cylinder-like battery can 11. The battery can 11 is made of, for example, iron (Fe) plated with nickel (Ni) and one end thereof is closed, and the other end is opened. In the battery can 11, a pair of insulating plates 12 and 13 are arranged to sandwich the spiral electrode body 20 perpendicularly to a periphery surface thereof.

A battery lid 14, as well as a safety valve mechanism 15 and a positive temperature coefficient element 16 (PTC) which are positioned inside the battery lid 14 are mounted in the open end of the battery can 11 by caulking via a gasket 17 to seal the inside of the battery can 11. The battery lid 14 is made of, for example, the same material as that of the battery can 11. The safety valve mechanism 15 is electrically connected to the battery lid 14 through the PTC element 16. When an internal pressure of the battery becomes more than a certain value due to the internal short circuit or heating from outside, a disk plate 15A is inverted to cut the electric connection between the battery lid 14 and the spiral electrode body 20. The PTC element 16 restricts electric currents, when its resistance increases with an increase in temperature, to prevent unusual heat generation due to high electric currents. The gasket 17 is made of, for example, an insulating material and asphalt is applied to the surface thereof.

The spiral electrode body 20 is wound around, for example, a center pin 24. A cathode lead 25 containing aluminum (Al) or the like is connected to the cathode 21 of the spiral electrode body 20, and an anode lead 26 containing nickel (Ni) or the like is connected to the anode 22. The cathode lead 25 is welded to the safety valve mechanism 15 to be electrically connected with the battery lid 14. The anode lead 26 is welded to the battery can 11 to be electrically connected.

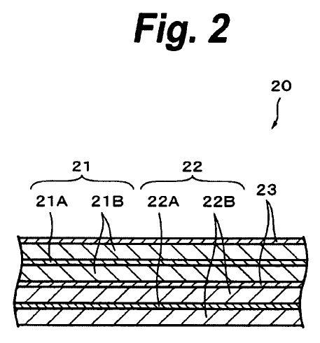

FIG. 2 is a partly enlarged cross-sectional view showing the spiral electrode body 20 shown in FIG. 1. The cathode 21 has, for example, a structure in which the cathode active material layer 21B is formed on both sides of the cathode current collector 21A that has a pair of opposed surfaces. The cathode active material layer 21B may be provided only on one side of the cathode current collector 21A, which is not illustrated. The cathode current collector 21A is made of, for example, metal foil such as aluminum foil. The cathode active material layer 21B include, for example, one, or two or more cathode materials capable of occluding and releasing lithium as a cathode active material and further include a conductive auxiliary agent such as graphite and a binder such as polyvinylidene fluoride, if necessary.

### [Cathode]

Preferable examples of the cathode material capable of occluding and releasing lithium include lithium containing compounds such as lithium oxide, lithium phosphorus oxide, lithium sulfide, or intercalation compounds containing lithium. Two or more of them may be used in combination. In order to obtain a high energy density, it is preferable to use lithium containing compounds which include lithium, transition metal element, and oxygen (O). Among them, the lithium containing compound which includes at least one selected from the group including cobalt (Co), nickel (Ni), manganese (Mn), and iron (Fe) as transition metal element is more preferable. Examples of the lithium containing compound include lithium composite oxides having a rock-salt layer structure represented by Chemical Formulae I, II, and III; lithium composite oxide having a spinel-type structure represented by Chemical Formula IV; and lithium composite phosphate having an olivine-type structure represented by Chemical Formula V. Specific examples thereof include LiNi_{0.50}CO_{0.20}Mn_{0.30}O₂, LiaCoO₂ (a≈1), LibNiO₂ (b≈1), Li_{c1}Ni_{c2}Co_{1-c2}O₂ (c1≈1, 0<c2<1), Li_{d}Mn₂O₄ (d≈1) or LiₑFePO₄ (e≈1).

Li_{f}Mn_{(l-g-h)}Ni_{g}M1ₕO₍₂₋ⱼ₎Fₖ (Chemical Formula I)

(wherein M1 represents at least one selected from the group including cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W). Values of f, g, h, j, and k are in the range of 0.8≦f≦1.2, 0<g<0.5, 0≦h≦0.5, g+h<t, −0.1≦j≦0.2, and 0≦k≦0.1. The composition of lithium changes depending on the charge-discharge state. The value of f represents a value in full discharged state.)

LiₘNi₍₁₋ₙ₎M2ₙO₍₂₋ₚ₎F_{q} (Chemical Formula II)

(wherein, M2 represents at least one selected from the group including cobalt (Co), manganese (Mn), magnesium (Mg), aluminium (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). Values of m, n, p, and q are in the range of 0.8≦m≦1.2, 0.005≦n≦0.5, −0.1≦p≦0.2, and 0≦q≦0.1. The composition of lithium changes depending on the charge-discharge state. The value of m represents a value in full discharged state.)

LiᵣCo₍₁₋ₛ₎M3ₛO₍₂₋ₜ₎Fᵤ (Chemical Formula III)

(wherein, M3 represents at least one selected from the group including nickel (Ni), manganese (Mn), magnesium (Mg), aluminium (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). Values of r, s, t, and u are in the range of 0.8≦r≦1.2, 0≦s<0.5, −0.1≦t≦0.2, and 0≦u≦0.1. The composition of lithium changes depending on the charge-discharge state. The value of r represents a value in full discharged state.)

LiᵥMn_{2-w}M4_{w}OₓF_{y} (Chemical Formula IV)

(wherein, M4 represents at least one selected from the group including cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W). Values of v, w, x, and y are in the range of 0.9≦v≦1.1, 0≦w≦0.6, 3.7≦x≦4.1, and 0≦y≦0.1. The composition of lithium changes depending on the charge-discharge state. The value of v represents a value in full discharged state.)

Li_{z}M5PO₄ (Chemical Formula V)

(wherein, M5 represents at least one selected from the group including cobalt (Co), manganese (Mn), iron (Fe), nickel (Ni), magnesium (Mg), aluminium (Al), boron (B), titanium (Ti), vanadium (V), niobium (Nb), copper (Cu), zinc (Zn), molybdenum (Mo), calcium (Ca), strontium (Sr), tungsten (W), and zirconium (Zr). A value of z is in the range of 0.9≦z≦1.1. The composition of lithium changes depending on the charge-discharge state. The value of z represents a value in full discharged state.)

Other examples of the cathode material capable of occluding and releasing lithium include inorganic compounds not containing lithium such as MnO₂, V₂O₅, V₆O₁₃, NiS, and MoS.

### [Anode]

The anode 22 has a structure, for example, in which the anode active material layer 22B is formed on both sides of the anode current collector 22A that has a pair of opposed surfaces. The anode active material layer 22B may be provided only on one side of the anode current collector 22A, which is not illustrated. The anode current collector 22A is made of, for example, metal foil such as copper foil.

The anode active material layer 22B include any one, or two or more of the anode material capable of occluding and releasing lithium as an anode active material and may also include the same binder as the cathode active material layer 21B, if necessary.

In the secondary battery, the electrochemical equivalent of the anode material capable of occluding and releasing lithium is larger than the electrochemical equivalent of the cathode 21. Thus, lithium metal is not precipitated on the anode 22 during the charge.

Further, the secondary battery is designed so that an open circuit voltage (namely, battery voltage) in the full charge state is within, for example, a range of 4.20 to 6.00 V, preferably 4.25 to 6.00 V, further preferably 4.30 to 4.55 V. For example, in the case where the open circuit voltage in the full charge state is 4.25 V or more, the discharge of lithium per unit mass is increased more than that of the battery of 4.20 V even if the same cathode active material is used. Depending on the case, the amount of the cathode active material and the anode active material is adjusted, thereby obtaining a high energy density.

Examples of the anode material capable of occluding and releasing lithium include carbon materials such as graphite, non-graphitizable carbon, graphitizable carbon, pyrolytic carbons, cokes, glassy carbons, organic polymer compound firing products, carbon fiber or activated carbon. Examples of such a coke include pitch coke, needle coke, or petroleum coke. Organic polymer compound firing products are obtained by firing and carbonizing polymeric materials such as a phenol resin and a furan resin at suitable temperatures. Some of them are categorized as non-graphitizable carbon or graphitizable carbon. Examples of the polymeric material include polyacethylene or polypyrrole. These carbon materials are desirable because there is very little change of the crystal structure thereof produced in charge and discharge and a high charge-discharge capacity and an excellent cycle characteristics can be obtained. Particularly, graphite is preferable since it has a large electrochemical equivalent and a high energy density can be obtained. Further, non-graphitizable carbon is preferable since an excellent characteristic can be obtained. Furthermore, a carbon material having a low charge-discharge potential, specifically, a carbon material having a charge-discharge potential close to that of lithium metal are preferable because a high energy density of the battery is easily realized.

Examples of the anode material capable of occluding and releasing lithium include materials capable of occluding and releasing lithium which contain at least one of metal elements and metalloid elements as a constituting element. The use of such a material allows for obtaining a high energy density. When they are used in combination with, particularly, carbon materials a high energy density and excellent cycle characteristics can be obtained, which is more preferable. Examples of the anode material may include the simple substance, alloy, and compound of the metal element or the metalloid element, or materials having the phases of one, or two or more such materials in at least one part thereof. In an embodiment, an alloy including one or more metallic elements and one or more metalloid elements is included in addition to an alloy including two or more metallic elements. Additionally, a nonmetallic element may be included. Examples of the structures of the materials include a solid solution, an eutectic (eutectic mixture), an intermetallic compound and a concomitant state of two or more of the structures.

Examples of a metal element constituting the anode material or a metalloid element include magnesium (Mg), boron (B), aluminium (Al), gallium (Ga), Indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), or platinum (Pt). These elements may be a crystalline substance or amorphous.

Preferable examples of the anode material include materials which contain metal elements or metalloid elements of Group 4B of the short period periodic table as the constituent element. The materials which contain at least one of silicon (Si) or tin (Sn) as the constituent element are particularly preferable. This is because silicon (Si) and tin (Sn) have a large ability to occlude and release lithium (Li) and a high energy density can be obtained.

Examples of the alloy of tin (Sn) include alloys containing at least one among the group including silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as the second constituting element other than tin (Sn). Examples of the alloy of silicon (Si) include alloys containing at least one selected from the group including tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as the second constituting element other than silicon (Si).

As a compound of tin (Sn) or a compound of silicon (Si), for example, a compound containing oxygen (O) or carbon (C) is listed. In addition to tin (Sn) or silicon (Si), the second constituting element described above may be contained.

Examples of the anode material capable of occluding and releasing lithium further include other metallic compounds or polymeric materials. Examples of other metallic compounds include oxides such as MnO₂, V₂O₅, and V₆O₁₃; sulfides such as NiS and MoS; or lithium nitrides such as LiN₃. Examples of the polymeric material include polyacethylene, polyaniline or polypyrrole.

### [Separator]

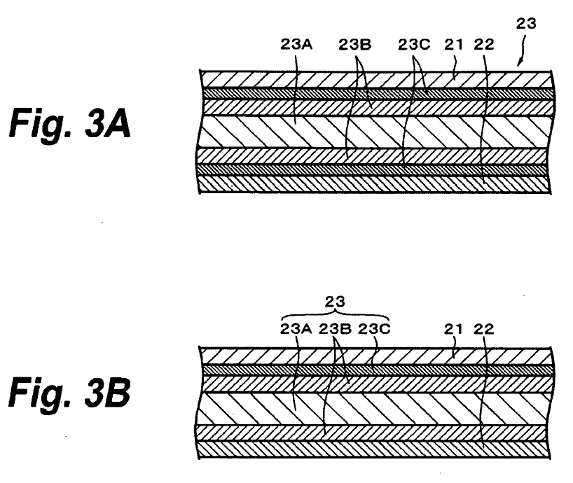

As shown in FIG. 3A and FIG. 3B, the separator 23 includes, for example, a base material layer 23A, surface layers 23B respectively provided on both sides of the base material layer 23A, and coating layers 23C respectively provided on each of the surface layers 23B.

The base material layer 23A is a micro-porous film obtained by using polyolefin resin materials such as polyethylene (PE) and polypropylene (PP). These materials can be used alone or in combination or a plurality of the materials can be copolymerized. Particularly, polyethylene (PE) is a preferable material for forming the base material layer 23A since it can exhibit a so-called shutdown effect in which a hole is clogged by the resin material melted in the range of 100 to 160° C. and is excellent in electrochemical stability. Further, other resins can be used to mix with polyethylene (PE) or polypropylene (PP) or copolymerize therewith as long as the resins have an electrochemical stability.

At least one resin material selected from the group including polyvinylidene fluoride (PVdF), polytetrafluoroethylene (PTFE), and polypropylene (PP) can be used for the surface layer 23B. These resin materials have a high electrochemical stability and hardly cause oxidative decomposition under an oxidative atmosphere in the vicinity of the cathode. Thus, the occurrence of a micro-short circuit is suppressed.

At least one of the wholly aromatic polyamide resin (hereinafter conveniently referred to as aramid), polyimide or ceramics can be used as the coating layer 23C. At least one of alumina (Al₂O₃), titania (TiO₂), silica (SiO₂), and zirconia (ZrO₂) can be used as ceramics. These materials have a high thermal stability and can reduce remarkable heat shrinkage of the separator 23 even when the temperature in the battery increases.

When the surface layer 23B is provided on both sides of the base material layer 23A, the coating layer 23C is provided on at least one surface of the surface layer 23B. That is, the structure in which the coating layer 23C is provided on both sides of the separator 23 as shown in FIG. 3A and the structure in which the coating layer 23C is provided only on the surface at the side of the cathode 21 of the separator 23 as shown in FIG. 3B can be used.

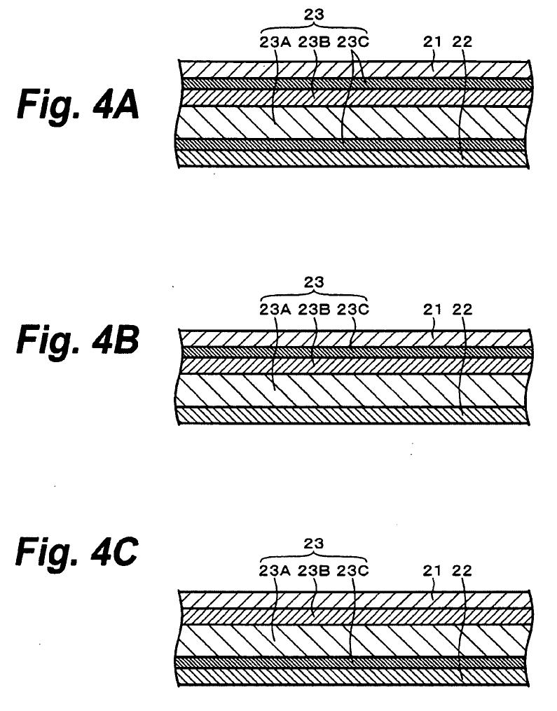

The surface layer 23B may be provided at least on the surface at the side of the cathode 21 of the base material layer 23A. Therefore, as shown in FIG. 4A, the surface layer 23B is provided only on the surface at the side of the cathode 21 of the base material layer 23A. The coating layer 23C may be provided on the surface of the surface layer 23B and the surface at the side of the anode 22 of the base material layer 23A.

As shown in FIG. 4B, the surface layer 23B is provided only on the surface at the side of the cathode 21 of the base material layer 23A. The coating layer 23C may be provided only on the surface of the surface layer 23B. As shown in FIG. 4C, the surface layer 23B is provided only on the surface at the side of the cathode 21 of the base material layer 23A. The coating layer 23C may be provided only on the surface at the side of the anode 22 of the base material layer 23A.

When the coating layer 23C is provided only on one surface, only the side of the other surface in which the coating layer 23C is not provided can be deformed by heat shrinkage. From the viewpoint of preventing a decrease in handling properties by the deformation of the separator 23, it is preferable that the coating layer 23C is provided on both surfaces of the separator 23 so as to be exposed.

As described above, the surface layer 23B excellent in electrochemical stability is provided at least on the surface at the side of the cathode of the base material layer 23A and the coating layer 23C excellent in thermal stability is provided on at least one outermost surface of the separator 23 so as to be exposed, which allows for preventing the oxidative decomposition and heat shrinkage of the separator 23.

It is preferable that the ratio of the thickness of the base material layer 23A to the thickness of the surface layer 23B is in the range of 1:0.05 to 1:1. When the thickness of the surface layer 23B is much thinner than the base material layer 23A, oxidation resistance is reduced. On the other hand, when the thickness of the surface layer 23B is much thicker than the base material layer 23A, the shutdown effect is reduced.

It is preferable that the thickness of the coating layer 23C is 0.5 μm or more and 5 μm or less. When the thickness of the coating layer 23C is less than 0.5 μm, the thermal stability is impaired. On the other hand, when the thickness of the coating layer 23C exceeds 5 μm, the battery capacity is decreased by an increase in the thickness of the separator 23.

The total thickness of the separator 23 is preferably within a range of 5 to 25 μm. This is because a short-circuit may be generated when the thickness is small, while the ionic permeability is reduced and the volumetric efficiency of the battery is also lowered when the thickness is large. The thickness was measured using a Digital Gauge DG110B, manufactured by Sony Manufacturing Systems Corporation.

It is preferable that the air permeability of the separator 23, as a value converted into the thickness of 20 μm, is in the range of 100 sec/100 cc to 600 sec/100 cc. This is because a short-circuit may be generated when the air permeability is low, while the ion conductivity is reduced when the air permeability is high. In this regard, the air permeability was measured using a Gurley type densometer G-B 2C, manufactured by TOYO SEIKI Co., Ltd.

It is preferable that the porosity of the separator 23 is in the range of 25% to 60%. This is because the ion conductivity is reduced when the porosity is low, while a short-circuit may be generated when the porosity is high. In this regard, the porosity was measured using a mercury porosimeter Poremaster 33P, manufactured by Yuasa Ionics Inc.

It is preferable that the thrust strength of the separator 23 is in the range of 200 gf to 1000 gf, as a value converted into the thickness of 20 μm. This is because a short-circuit may be generated when the thrust strength is low, while the ion conductivity is reduced when the thrust strength is high. The thrust strength was measured using a handy compression tester KES-G5, manufactured by Kato Tech Co., Ltd.

The separator 23 having the structure in which the coating layer 23C which contains at least one selected from the group including aramid, polyimide, and ceramics is provided has been described. It is not always necessary that the separator has the structure. The surface layer 23B may be formed using materials such as polyvinylidene fluoride mixed with at least one selected from the group including aramid, polyimide, and ceramics, polytetrafluoroethylene, and polypropylene so that at least one selected from the group including aramid, polyimide, and ceramics is present on the surface of the surface layer 23B.

The separator 23 is impregnated with a nonaqueous electrolytic solution which is a liquid electrolyte. Hereinafter, the nonaqueous electrolytic solution will be described.

### [Nonaqueous Electrolytic Solution]

Usable examples of the nonaqueous electrolytic solution include electrolyte salts and organic solvents which are generally used for secondary batteries.

Cyclic carbonate esters such as ethylene carbonate (EC) and propylene carbonate (PC) can be used as the solvents. It is preferable to use either or, particularly, both of ethylene carbonate (EC) and propylene carbonate (PC). This is because the cycle characteristics can be improved.

In addition to cyclic carbonate esters, usable examples of the solvent include dimethyl carbonate (DMC), diethyl carbonate (DEC), ethylmethyl carbonate (EMC), dipropyl carbonate (DPC), ethylpropyl carbonate (EPC) or chain carbonate esters thereof.

It is preferable that the solvent further contains 2,4-difluoroanisole or vinylene carbonate (VC). This is because 2,4-difluoroanisole can improve the electric discharge capacity and vinylene carbonate can further improve the cycle characteristics. Therefore, it is preferable to use these materials in combination since both the discharging capacity and cycle characteristics are improved.

Other examples of the solvent include butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, methyl acetate, methyl propionate, acetonitrile, glutaronitrile, adiponitrile, methoxy acetonitrile, 3-methoxy propionitrile, N,N-dimethyl formamide, N-methylpyrrolizinone, N-methyloxazolidinone, N,N-dimethyl imidazolidinone, nitromethane, nitroethane, sulfolane, dimethyl sulfoxide, or trimethyl phosphate.

In some cases, compounds in which at least one hydrogen is substituted by a halogen group among the nonaqueous solvents can improve the reversibility of the electrode reaction depending on the kind of electrode to be combined. Thus, this case is preferable.

Examples of the electrolyte salt include inorganic lithium salts such as lithium hexafluorophosphate (LiPF₆), lithium tetrafluoroborate (LiBF₄), lithium hexafluoroarsenate (LiAsF₆), lithium hexafluoroantimonate (LiSbF₆), lithium perchlorate (LiClI₄), lithium tetrachloroaluminate (LiAlCl₄); and perfluoroalkanesulfonate derivatives such as lithium trifluoromethanesulfonate (LiCF₃SO₃), lithium bis(trifluoromethanesulfonyl) imide (LiN(CF₃SO₂)₂), lithium bis (pentafluoroethanesulfonyl) imide (LiN(C₂F₅SO₂)₂), and lithium tris (trifluoromethanesulfonyl)methide (LiC(CF₃SO₂)₃). These salts may be used alone or in combination. Among them, lithium hexafluorophosphate (LiPF₆) is particularly preferable because a high ion-conductivity can be obtained and cycle characteristics can be improved.

### [Production of Secondary Battery]

The secondary battery may be formed, for example, in the following manner.

### [Production of Separator]

The separator 23 may be formed, for example, in the following manner.

First, a layered product in which the surface layer 23B is formed on at least one surface of the base material layer 23A is formed by, for example, a general method used in the past. Then, at least one of aramid, polyimide, and ceramic powder is dissolved in a water-soluble organic solvent in which these materials are soluble to produce a slurry. A micro-porous thin film layer can be obtained by applying the slurry to at least one surface of the surface layer 23B and bringing into contact with a poor solvent.

Examples of the water-soluble organic solvent include polar solvents such as N-methyl-2-pyrrolidone (NMP), N,N-dimethylacetamide (DAMc), and N,N-dimethylformamide (DMF). Examples of the poor solvent include water, ethanol, or methanol.

### [Production of Secondary Battery]

For example, the cathode active material, conductive agent, and binder are mixed to prepare a cathode mixture and then the cathode mixture is dispersed in a solvent such as N-methyl-2-pyrrolidone (NMP) to give a paste-like cathode mixture slurry. Next, the cathode mixture slurry is applied to the cathode current collector 21A and the solvent is dried, followed by compression molding with a roll presser to form the cathode active material layer 21B. Then, the cathode 21 is fabricated.

Further, the anode active material and the binder are mixed to prepare an anode mixture and then the anode mixture is dispersed in N-methyl-2-pyrrolidone as to give a past-like anode mixture slurry. Next, the anode mixture slurry is applied to the anode current collector 22A and the solvent is dried, followed by compression molding with a roll presser to form the anode active material layer 22B. Then, the anode 22 is fabricated.

Then, the cathode lead 25 is fixed to the cathode current collector 21A with welding or the like, and the anode lead 26 is fixed to the anode current collector 22A with welding or the like. Thereafter, the cathode 21 and the anode 22 are wound sandwiching the separator 23 therebetween, a tip portion of the cathode lead 25 is welded to the safety valve mechanism 15, a tip portion of the anode lead 26 is welded to the battery can 11, and the wound cathode 21 and anode 22 are sandwiched between a pair of the insulating plates 12 and 13, and then housed inside the battery can 11. After housing the cathode 21 and anode 22 inside the battery can 11, the electrolytic solution is injected into the battery can 11 to be impregnated into the separator 23. Thereafter, the battery lid 14, the safety valve mechanism 15, and the PTC element 16 were caulked and fixed to an opening end of the battery can 11 through the gasket 17. As a result, the secondary battery shown in FIG. 1 can be obtained.

In the secondary battery according to the first embodiment, the open circuit voltage in the full charge state is within, for example, a range of 4.25 to 6.00 V, preferably 4.25 to 4.55 V. When the separator is used under an oxidative atmosphere at the high charging voltage, the cause oxidative decomposition of the separator is suppressed, the heat shrinkage of the separator with the temperature rise in the battery is also suppressed, and a secondary battery capable of balancing high safety and high battery performance can be obtained. The above-described separator ensures a high safety for not only a secondary battery with a high charging voltage exceeding 4.2 V but also a secondary battery with a charging voltage of 4.2 V or less, and thus it can be used for the secondary battery with a charging voltage of 4.2 V or less.

### EXAMPLES

Hereinafter, specific examples will be described with reference to examples. However, the embodiments are not to be construed as being limited to these examples.

The structures of respective separators to be used in Examples 1 to 7 and Comparative examples 1 and 2 are shown in Table 1.

TABLE 1

| | | | | COATING LAYER | | | | | |
|---|---|---|---|---|---|---|---|---|---|
| | | | | | | THICKNESS | | | |
| | | | | | | OF | TOTAL | AIR | |
| | BASE | SURFACE LAYER | | COATING | | COATING | THICK- | PERME- | THRUST |
| | MATERIAL | CATHODE | ANODE | LAYER | SURFACE TO | LAYER | NESS | ABILITY | STRENGTH |
| | LAYER | SIDE | SIDE | MATERIALS | BE COATED | [μm] | [μm] | [sec/100 cc] | [gf] |
| EXAMPLE 1 | PE | PP | PP | ARAMID | SURFACE AT | 2 | 20 | 360 | 420 |
| | | | | | OPPOSITE SIDE | | | | |
| | | | | | OF ANODE | | | | |
| EXAMPLE 2 | PE | PP | PP | ALUMINA | BOTH SIDES | 1 | 20 | 300 | 400 |
| EXAMPLE 3 | PE | PP | PP | SILICA 50% | BOTH SIDES | 2 | 20 | 300 | 420 |
| | | | | ARAMID 50% | | | | | |
| EXAMPLE 4 | PE | PP | PP | TITANIA 50% | SURFACE AT | 3 | 20 | 320 | 450 |
| | | | | ARAMID 50% | OPPOSITE SIDE | | | | |
| | | | | | OF ANODE | | | | |
| EXAMPLE 5 | PE | PTFE | PTFE | TITANIA 50% | SURFACE AT | 2 | 20 | 310 | 450 |
| | | | | ARAMID 50% | OPPOSITE SIDE | | | | |
| | | | | | OF ANODE | | | | |
| EXAMPLE 6 | PE | PP | PP | ARAMID 50% | BOTH SIDES | 3 | 20 | 300 | 450 |
| | | | | ALUMINA | | | | | |
| | | | | 50% | | | | | |
| EXAMPLE 7 | PE | PP | PP | POLYIMIDE | BOTH SIDES | 2 | 20 | 360 | 460 |
| COMPARATIVE | PE | — | — | — | — | — | 20 | 300 | 400 |
| EXAMPLE 1 | | | | | | | | | |
| COMPARATIVE | PE | PP | PP | — | — | — | 20 | 330 | 450 |
| EXAMPLE 2 | | | | | | | | | |

The secondary battery was produced in the following manner using the separator having the structure shown in Table 1.

### [Production of Cathode]

First, the cathode active material was produced. Commercially available nickel nitrate (Ni(NO₃)₂), cobalt nitrate (Co(NO₃)₂), and manganese nitrate (Mn(NO₃)₂) as aqueous solutions were mixed so that a molar ratio of nickel (Ni), cobalt (Co), and manganese (Mn) was 0.50, 0.20, and 0.30, respectively. An aqueous ammonia was added dropwise to the resulting mixed solution while the mixed solution was sufficiently stirred and a composite hydroxide was obtained.

Then, the composite hydroxide obtained in the above-described manner was mixed with lithium hydroxide (LiOH), which was placed in an electric furnace and fired at 900° C. for 10 hours to obtain a fired product. Thereafter, the fired product was ground and lithium composite oxide powder as a cathode active material was obtained.

When the lithium composite oxide powder was analyzed by atomic absorption spectrometry (ASS), it was confirmed that the analytical value of the average chemical composition was LiNi_{0.50}Co_{0.20}Mn_{0.30}O₂. When an average particle diameter was measured by laser diffractometry, the average particle diameter was 13 μm. Further, when X-ray diffraction measurement was carried out, the powder was similar to a pattern of LiNiO₂ described in International Center for Diffraction Data (ICDD) card 09-0063. It was confirmed that the rock-salt layer structure similar to that of LiNiO₂ was formed. Furthermore, when the powder was observed with a Scanning Electron Microscope (SEM), spherical particles in which primary particles having a size of 0.1 to 5 μm were aggregated were seen.

The obtained powder of LiNi_{0.50}Co_{0.20}Mn_{0.30}O₂, graphite as a conductive agent, polyvinylidene fluoride as a binder were mixed at a mass ratio (powder of LiNi_{0.50}Co_{0.20}Mn_{0.30}O₂:graphite:polyvinylidene fluoride=86:10:4) to prepare a cathode mixture. Thereafter, the cathode mixture was dispersed in N-methyl-2-pyrrolidone as a solvent, thereby obtaining a cathode mixture slurry. The cathode mixture slurry was uniformly applied over both faces of the cathode current collector made of aluminum (Al) foil in a strip shape having a thickness of 20 μm, dried, and compression molded by a roll presser, thereby forming the cathode active material layer and fabricating the cathode. At that time, the total thickness of the cathode was 150 μm. Then, the cathode lead made of aluminium (Al) was attached to one end of the cathode current collector.

### (Production of Anode)

Spheroidal graphite powder having an average particle diameter of 30 μm as an anode active material and polyvinylidene fluoride as a binder were mixed at a mass ratio (spheroidal graphite powder:polyvinylidene fluoride=90:10) to prepare an anode mixture. Then, the anode mixture was dispersed in N-methyl-2-pyrrolidone as a solvent to give an anode mixture slurry. Thereafter, the anode mixture slurry was uniformly applied over both faces of the anode current collector made of copper (Cu) foil in a strip shape having a thickness of 15 μm, which was hot-press molded to form the anode active material layer and the anode was fabricated. The thickness of the anode was 160 μm. Thereafter, the anode lead made of nickel (Ni) was attached to one end of the anode current collector. The electrochemical equivalent ratio of the cathode and the anode was designed so that the capacity of the anode would be represented by a capacity component determined by occlusion and release of lithium.

The cathode and the anode were respectively produced and then the separator of a micro-porous film was prepared. The anode, the separator, the cathode, and the separator were stacked in this order. The stacked product was spirally wound many times to form a spiral electrode body having a jelly roll shape. The separators having structures described in Table 1 were used in each of Example and Comparative example.

After producing the spiral electrode body, the spiral electrode body was sandwiched between a pair of the insulating plates. The anode lead was welded to the battery can and the cathode lead was welded to the safety valve mechanism. Then, the spiral electrode body was housed in the battery can made of iron plated with nickel. Thereafter, 4.0 g of electrolytic solution was injected into the battery can under reduced pressure. LiPF₆ as an electrolyte salt was dissolved in a mixed solvent (nonaqueous solvent) obtained by mixing ethylene carbonate (EC), dimethyl carbonate (DMC), and vinylene carbonate (VC) at a mass ratio ((EC):(DMC):(VC)=35:60:1) so as to be 1.5 mol/kg, which was used as the electrolytic solution.

After injecting the electrolytic solution into the battery can, the battery lid was caulked to the battery can through the gasket whose surface was coated with asphalt and a cylindrical lithium-ion secondary battery having a diameter of 14 mm and a height of 65 mm was obtained.

### [Evaluation of Cylindrical Lithium-Ion Secondary Battery]

### (a) Cycle Characteristics

Each cylindrical lithium-ion secondary battery obtained as described above was placed in a thermostat at 40° C. and the charging was performed at a constant current of 100 mA until the battery voltage reached to a predetermined voltage. Thereafter, the charging was performed at a predetermined constant voltage until the total charging time reached 2.5 hours. The battery voltages were 4.20 V, 4.30 V, 4.35 V, 4.40 V, 4.50 V, and 4.55 V, respectively. Then, the discharging was performed at a constant current of 2000 mA until the battery voltage reached to 3.00 V and then 300 cycles of the charging and discharging were carried out. The discharge capacity maintenance ratio, namely, the ratio of the discharge capacity of the 300th cycle to the discharge capacity of the 1st cycle was determined by the equation {(discharge capacity of the 300th cycle/discharge capacity of the 1st cycle)×100}.

### (b) Continuous Charging Characteristics

Each cylindrical lithium-ion secondary battery obtained as described above was placed in a thermostat at 80° C. and the charging was performed at a constant current of 100 mA until the battery voltage reached to a predetermined voltage. Thereafter, the charging was performed at a predetermined constant voltage until the total charging time reached 100 hours. Then, the time when current leakage occurred was evaluated. The battery voltages were 4.20 V, 4.30 V, 4.35 V, 4.40 V, 4.50 V, and 4.55 V, respectively. In the case where the current leakage was not detected even when the total charging time reached 100 hours, it was determined that the current leakage did not occur.

### (c) External Short Circuit

Each of the cylindrical lithium-ion secondary batteries obtained by the above-described manner was charged at a constant current of 100 mA at ordinary temperature until the battery voltage reached to a predetermined voltage. Then, the charging was performed at a predetermined constant voltage until the total charging time reached 2.5 hours. Thereafter, the external short-circuit test was performed in a thermostat set to 90° C. and the battery temperature was measured.

When the battery temperature exceeds 120° C. by the test, the PTC element is necessary. When the battery temperature is 120° C. or less, the shutdown of the separator allows for the interruption and thus the PTC element is not necessary. Therefore, it can be said that the battery that can be interrupted by the shutdown of the separator even if the battery temperature does not exceed 120° C. and the PTC element is not disposed has a more excellent safety.

Evaluation results of cycle characteristics are shown in Table 2. Evaluation results of continuous charging characteristics are shown in Table 3. Evaluation results of external short circuit are shown in Table 3.

TABLE 2

| | DISCHARGE CAPACITY | | | | | |
|---|---|---|---|---|---|---|
| | MAINTENANCE RATIO [%] | | | | | |
| | 4.20 V | 4.30 V | 4.35 V | 4.40 V | 4.50 V | 4.55 V |
| EXAMPLE 1 | 91 | 92 | 89 | 86 | 82 | 80 |
| EXAMPLE 2 | 93 | 92 | 91 | 88 | 85 | 85 |
| EXAMPLE 3 | 92 | 91 | 88 | 85 | 85 | 83 |
| EXAMPLE 4 | 93 | 90 | 89 | 86 | 86 | 83 |
| EXAMPLE 5 | 93 | 90 | 97 | 86 | 84 | 82 |
| EXAMPLE 6 | 92 | 92 | 89 | 87 | 88 | 84 |
| EXAMPLE 7 | 91 | 90 | 86 | 83 | 80 | 78 |
| COMPAR- | 91 | 75 | 73 | 60 | 60 | 55 |
| ATIVE | | | | | | |
| EXAMPLE 1 | | | | | | |
| COMPAR- | 93 | 92 | 90 | 87 | 83 | 81 |
| ATIVE | | | | | | |
| EXAMPLE 2 | | | | | | |

TABLE 3

| | TIME WHEN CURRENT | | | | | |
|---|---|---|---|---|---|---|
| | LEAKAGE OCCURRED [HOURS] | | | | | |
| | 4.20 V | 4.30 V | 4.35 V | 4.40 V | 4.50 V | 4.55 V |
| EXAMPLE 1 | — | — | — | — | — | — |
| EXAMPLE 2 | — | — | — | — | — | — |
| EXAMPLE 3 | — | — | — | — | — | — |
| EXAMPLE 4 | — | — | — | — | — | — |
| EXAMPLE 5 | — | — | — | — | — | — |
| EXAMPLE 6 | — | — | — | — | — | — |
| EXAMPLE 7 | — | — | — | — | — | — |
| COMPAR- | — | 100 | 50 | 50 | 50 | 50 |
| ATIVE | | | | | | |
| EXAMPLE 1 | | | | | | |
| COMPAR- | — | — | — | — | — | — |
| ATIVE | | | | | | |
| EXAMPLE 2 | | | | | | |

In Table 3, the batteries in which the current leakage was not detected even when the total charging time reached 100 hours were indicated by “-”.

TABLE 4

| | EXTERNAL SHORT-CIRCUIT TEST | | | | | |
|---|---|---|---|---|---|---|
| | 4.20 V | 4.30 V | 4.35 V | 4.40 V | 4.50 V | 4.55 V |
| EXAMPLE 1 | ◯ | ◯ | ◯ | ◯ | ◯ | ◯ |
| EXAMPLE 2 | ◯ | ◯ | ◯ | ◯ | ◯ | ◯ |
| EXAMPLE 3 | ◯ | ◯ | ◯ | ◯ | ◯ | ◯ |
| EXAMPLE 4 | ◯ | ◯ | ◯ | ◯ | ◯ | ◯ |
| EXAMPLE 5 | ◯ | ◯ | ◯ | ◯ | ◯ | ◯ |
| EXAMPLE 6 | ◯ | ◯ | ◯ | ◯ | ◯ | ◯ |
| EXAMPLE 7 | ◯ | ◯ | ◯ | ◯ | ◯ | ◯ |
| COMPAR- | X | X | X | X | X | X |
| ATIVE | | | | | | |
| EXAMPLE 1 | | | | | | |
| COMPAR- | X | X | X | X | X | X |
| ATIVE | | | | | | |
| EXAMPLE 2 | | | | | | |

In Table 4, the batteries in which the battery temperature was 120° C. or less were indicated by “◯” and the batteries in which the battery temperature exceeded 120° C. were indicated by “x” However, it is not to say that the batteries indicated by “x” are bad, but the disposition of the PTC element is necessary.

As is apparent from Table 2, although the capacity maintenance rate was slightly decreased as the voltage increased in each of the cylindrical lithium-ion secondary batteries of Examples 1 to 7 using the separator of the structure, approximately 80% of the capacity maintenance rate could be maintained even when the charging voltage exceeded 4.55 V. In Comparative example 2 where a layered separator in which the surface layer of polypropylene was provided on both sides of the base material layer made of polyethylene was used, a capacity maintenance rate nearly equivalent to that of each Comparative example could be maintained.

On the other hand, in Comparative example 1 where the separator of polyethylene monolayer was used, the capacity maintenance rate was greatly decreased when the charging voltage exceeded 4.2 V. When the charging voltage was 4.55 V, the capacity maintenance rate was 55%.

This is because the oxidative atmosphere in the vicinity of the cathode was increased as the charging voltage become higher and then the separator having only the base material layer of Comparative example 1 was oxidatively decomposed, which leaded, for example, to the occurrence of a micro-short circuit and the reduction of cycle characteristics. On the other hand, in each Example and Comparative example 2 where the surface layer with a high electrochemical stability was provided, the oxidative decomposition of the separator did not occur. Therefore, it is considered that cycle characteristics were reduced with the rise of the charging voltage, however, a large reduction as that of Comparative example 1 did not occur.

Even when the coating layer is provided on both surfaces of the separator,

As is apparent from Table 3, it is found that the current leakage did not occur in each of Examples and Comparative examples when the charging voltage was 4.20 V, however, the current leakage occurred in only the cylindrical lithium-ion secondary battery of Comparative example 1 when the charging voltage was 4.30 V or more.

This is because the only of the separator of Comparative example 1 was oxidatively decomposed in the case of a high charging voltage exceeding 4.20 V as described above and thus the cathode and the anode were short-circuited, which caused the current leakage.

As apparent from Table 4, when the external short-circuit test was performed in a thermostat set to 90° C., the battery temperature was 120° C. or less at any charging voltages in Examples 1 to 7. On the other hand, the battery temperature exceeded 120° C. at any charging voltages in Comparative examples 1 and 2.

This is because the heat shrinkage of the separator which is caused at any charging voltage due to an increase in the temperature in the battery and the oxidative decomposition of the separator which is caused at a high charging voltage exceeding 4.20 V can be prevented by providing the coating layer excellent in thermal stability on the surface layer excellent in electrochemical stability in each Example.

On the other hand, in Comparative example 1, polyethylene of the base material layer is excellent in thermal stability. However, the oxidative decomposition of the separator is caused at a high charging voltage exceeding 4.20 V. Therefore, it is considered that a short circuit of the cathode and the anode is generated and the battery temperature exceeds 120° C.

In Comparative example 2, the electrochemical stability is excellent since the surface layer is provided. However, the thermal stability is low and thus the heat shrinkage of the separator is caused. Therefore, it is considered that the cathode is directly opposed to the anode and thus a short circuit is generated and the battery temperature exceeds 120° C.

The above-described results show that high safety and high battery performance can be balanced by using the separator in which the surface layer excellent in electrochemical stability and the coating layer excellent in thermal stability are provided in the case of the secondary battery at a high charging voltage exceeding 4.20 V.

It should be understood by those skilled in the art that various modifications, combinations, sub-combinations and alterations may occur depending on design requirements and other factors insofar as they are within the scope of the appended claims or the equivalents thereof. For example, the embodiments have been described with reference to the cylinder-type battery, but they are not limited thereto. The battery can have various shapes and sizes. For example, a battery in which a metal container is used as an exterior member, such as square-shaped, coin-shaped and button-shaped batteries and a thin battery whose outer face is made of a laminate film.

Alternatively, another electrolyte, for example, a gel electrolyte in which a electrolytic solution is retained by a polymeric compound may be used in place of the electrolytic solution. The electrolytic solution (namely, liquid solvents, electrolyte salts, and additive agents) is as described above. Examples of a polymeric compound include polyacrylonitrile, polyvinylidene fluoride, a copolymer having a repeating unit derived from vinylidene fluoride and hexafluoro propylene, polytetrafluoroethylene, polyhexafluoro propylene, polyethylene oxide, polypropylene oxide, polyphosphazen, polysiloxane, polyvinyl acetate, polyvinyl alcohol, polymethyl methacrylate, polyacrylic acid, polymethacrylic acid, styrene butadiene rubber, nitrile-butadiene rubber, polystyrene, or polycarbonate. Particularly, taking into consideration electrochemical stability, it is preferable to use polyacrylonitrile, polyvinylidene fluoride, polyhexafluoropropylene, or polyethylene oxide.

Other examples of the electrolyte include a solid polymer electrolyte using an ion-conducting polymer and an inorganic solid electrolyte using an ion-conducting inorganic solid electrolyte. These electrolytes may be used either alone or in combination with other electrolytes. Examples of the polymeric compound which can be used for the solid polymer electrolyte include polyether, polyester, polyphosphazen, or polysiloxane. Examples of the inorganic solid electrolyte include ion-conducting ceramics, ion-conducting crystal or ion-conducting glass.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolyte battery comprising:
an anode; and
a cathode placed opposite the anode via a separator,
wherein the separator comprises a base material layer which includes a polyolefin resin material and a surface layer which is provided at least on the surface at the side of the cathode of the base material layer and includes at least one selected from the group consisting of polyvinylidene fluoride, polytetrafluoroethylene, and polypropylene, and
at least one selected from the group consisting of aramid, polyimide, and ceramics is present on the outermost surface of the surface layer; and
wherein an open circuit voltage in the full charge state is within a range of 4.25 to 6.00 V per a pair of the cathode and the anode,

2. The nonaqueous electrolyte battery according to claim 1,
wherein a coating layer is provided on at least one outermost surface of the separator, the coating layer containing at least one selected from the group consisting of a wholly aromatic polyamide resin, polyimide, and ceramic.

3. The nonaqueous electrolyte battery according to claim 2,
wherein the ratio of the thickness of the base material layer to the thickness of the surface layer is in the range of 1:0.05 to 1:1.

4. The nonaqueous electrolyte battery according to claim 2,
wherein the thickness of the coating layer is 0.5 μm or more and 5 μm or less.

5. The nonaqueous electrolyte battery according to claim 1,
wherein the thickness of the separator is 5 μm or more and 25 μm or less.

6. The nonaqueous electrolyte battery according to claim 1,
wherein the air permeability of the separator is in the range of 100 sec/100 cc to 600 sec/100 cc.

7. The nonaqueous electrolyte battery according to claim 1,
wherein the porosity of the separator is 25% or more and 60% or less.

8. The nonaqueous electrolyte battery according to claim 1,
wherein the thrust strength of the separator is 200 gf or more and 1000 gf or less.

9. The nonaqucous electrolyte battery according to claim 1,
wherein the open circuit voltage in the full charge state per a pair of the cathode and the anode is within a range of 4.25 to 4.55 V.
